(19) United States
(12) Patent Application Publication
(10) Pub. No.: US 2015/0162695 A1
(43) Pub. Date: Jun. 11, 2015

(54) LOCKING STRUCTURE OF TERMINAL FITTING, BULB SOCKET, AND ILLUMINATION DEVICE

(71) Applicant: YAZAKI CORPORATION, Tokyo (JP)

(72) Inventors: Hideki YAMANAKA, Makinohara-shi (JP); Shinji YAMADA, Yokohama-shi (JP); Hirohito TORIYAMA, Yokohama-shi (JP)

(73) Assignee: YAZAKI CORPORATION, Tokyo (JP)

(21) Appl. No.: 14/566,287

(22) Filed: Dec. 10, 2014

(30) Foreign Application Priority Data
Dec. 11, 2013 (JP) 2013-255868

(51) Int. Cl. H01R 13/506; F21V 13/02; F21V 23/06; H01R 13/627; F21V 19/00

(52) U.S. Cl. CPC H01R 13/506; H01R 13/6271; F21V 19/0005; F21V 23/06; F21V 13/02

(57) ABSTRACT

A locking structure of a terminal fitting includes a terminal fitting, a terminal containing portion that holds and contains the terminal fitting therein, and a restriction member that is attached to the terminal containing portion. The terminal fitting is locked in the terminal containing portion by a lock projection of the terminal fitting. The terminal containing portion has a guide space formed by a gap between the lock projection and an inner wall surface of the terminal containing portion to guide the terminal fitting to a lock position therethrough. The restriction member has a restriction wall which is butted by the lock projection of the terminal fitting and thereby prevents from releasing of the terminal fitting when the terminal fitting is moved in such a direction as to be released from the terminal containing portion.

### BACKGROUND

The present disclosure relates to a locking structure of a terminal fitting in which the terminal fitting is locked in a terminal containing portion by means of a lock projection of the terminal filling, a bulb socket having the lock structure, and an illumination device having the bulb socket.

A related locking structure of a terminal fitting in which a terminal fitting is held by and contained in a terminal containing portion of a connector, a bulb socket, or the like is disclosed in JP-A-2013-152898, which discloses a bulb socket in which a terminal fitting is locked in a terminal containing portion provided in a socket main body by means of a lock piece (lock projection) formed by cutting and erecting a portion of the terminal fitting.

However, the locking structure of a terminal fitting disclosed in JP-A-2013-152898 has the following problem. The lock piece (lock projection) is locked on a projection provided in the terminal containing portion. Therefore, as the lock piece is moved toward a lock position, it needs to be deformed to a large extent in the direction opposite to its projection direction to climb over the projection. As a result, its resilience that is necessary for recovery in the projection direction may be decreased, possibly resulting in lowering of the locking force.

### SUMMARY

The present disclosure has been made in the above circumstances, and an object of the present disclosure is therefore to provide a locking structure of a terminal fitting which can prevent lowering of the force for locking of the metal fitting, a bulb socket having the lock structure, and an illumination device having the bulb socket.

To solve the above problem and attain the above object, the present disclosure provides, a locking structure of a terminal fitting, comprising:

a terminal fitting;

a terminal containing portion that holds and contains the terminal fitting therein; and

a restriction member that is separate from and is attached to the terminal containing portion,

wherein the terminal fitting is locked in the terminal containing portion by a lock projection of the terminal fitting;

wherein the terminal containing portion has a guide space formed by a gap between the lock projection and an inner wall surface of the terminal containing portion to guide the terminal fitting to a lock position therethrough; and

wherein the restriction member has a restriction wall which is butted by the lock projection of the terminal fitting and thereby prevents from releasing of the terminal fitting when the terminal fitting is moved in such a direction as to be released from the terminal containing portion.

By the above configuration, the locking structure can prevent deformation of the lock projection because the terminal fitting is moved to the lock position while the lock projection moves through the guide space without coming into contact with the inner wall surface of the terminal containing portion, and also can produce a strong locking force because the restriction member prevents coming-off of the terminal fitting. As a result, lowering of the force for locking of the metal fitting can be prevented.

For example, the terminal fitting has a press-fit portion which is held by the terminal containing portion, and the terminal containing portion has a terminal press-fit holding portion which is press-fitted with the press-fit portion and thereby holds the terminal fitting at the lock position.

By the above configuration, the terminal fitting can be held at the lock position as a result of the terminal press-fit holding portion's being press-fitted with the press-fit portion of the terminal fitting. This facilitates assembling work.

According to the present disclosure, there is also provided a bulb socket for supplying power to a bulb as a light source, comprising:

the locking structure of the terminal fitting described in the above,

wherein the terminal fitting has a terminal portion which is connected to the bulb; and

wherein the terminal containing portion is provided in a socket main body of the bulb socket.

By the above configuration, since deformation of the lock projection can be prevented because the terminal fitting is moved to the lock position while the lock projection moves through the guide space without coming into contact with the inner wall surface of the terminal containing portion. Furthermore, a strong locking force can be produced because the restriction member prevents coming-off of the terminal fitting. As a result, lowering of the force for locking of the metal fitting can be prevented.

According to the present disclosure, there is also provided an illumination device comprising:

a bulb as a light source;

a translucent lens for transmitting, to outside the illumination device, light emitted from the bulb;

a light leakage prevention cover that prevents leakage of light through a portion other than the translucent lens; and

the bulb socket described in the above.

By the above configuration, lowering of the force for locking of the metal fitting can be prevented as in the bulb socket as described above.

For example, the socket main body has a cover lock portion which is locked on the light leakage prevention cover, the light leakage prevention cover has a lock counterpart portion on which the cover lock portion is locked so as to be supported by the cover lock portion, and the restriction member is attached to the terminal containing portion so that the restriction wall is placed between the terminal fitting located at the lock position and the cover lock portion and is placed closer to a destination side in a releasing direction, in which the terminal fitting is released from the terminal containing portion, than the lock projection.

By the above configuration, the inner wall surface of the cover lock portion which is made stronger as a result of its locking on the lock counterpart portion of the light leakage prevention cover prevents bending or positional deviation of the restriction wall. As a result, the force for locking of the terminal fitting can be increased further.

For example, the restriction member is integrally formed on the light leakage prevention cover.

By the above configuration, the restriction member is integral with the light leakage prevention cover. Therefore, the number of components can be reduced, as a result of which assembling work can be facilitated.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is an exploded perspective view of an illumination device according to a first embodiment of the present disclosure;

FIG. 2A is a perspective view of the illumination device as viewed from the side of a translucent lens, and FIG. 2B is a perspective view of the illumination device as viewed from the side of a light leakage prevention cover;

FIG. 3 is a perspective view, as viewed from the side of the light leakage prevention cover, of the illumination device to which the translucent lens has not been attached yet;

FIG. 4 is a front view, as viewed from the side of the light leakage prevention cover, of the illumination device in the same state as shown in FIG. 3;

FIG. 5A is a sectional view of the illumination device taken along line A-A in FIG. 4, and FIG. 5B is an enlarged view of part of FIG. 5A, that is, a restriction wall and its neighborhood;

FIG. 6 is a view of the illumination device as view from the direction indicated by arrow A′ in FIG. 4;

FIG. 7A is a sectional view of the illumination device taken along line B-B in FIG. 6, and FIG. 7B is an enlarged view of part of FIG. 7A, that is, a restriction wall and its neighborhood;

FIG. 8 is a front view of a socket main body as viewed from the side of an opening of an insertion hole;

FIG. 9A is a sectional view of the socket main body taken along line C-C in FIG. 8, and FIG. 9B is an enlarged view of part of FIG. 9A, that is, a terminal containing portion and its neighborhood;

FIG. 10 is a perspective view of the socket main body;

FIG. 11 is an enlarged view, as viewed from the side of the opening of the insertion hole, of part of the socket main body to which terminal fittings are attached;

FIG. 12 is a perspective view of one of the terminal fittings;

FIG. 13A is a sectional view of the pair of terminal fittings, and FIG. 13B is an enlarged view of part of FIG. 13A, that is, a lock projection and its neighborhood;

FIG. 14 shows a state before insertion of the pair of terminal fittings into respective terminal containing portions of the socket main body;

FIG. 15A shows a state immediately before the pair of terminal fittings reach lock positions, and FIG. 15B is an enlarged view of part of FIG. 15A, that is, one terminal containing portion and its neighborhood;

FIG. 16A shows a state that the terminal fittings are set in place, and

FIG. 16B is an enlarged view of part of FIG. 16A, that is, one terminal containing portion and its neighborhood;

FIG. 17 shows a state before attachment of a restriction member to the socket main body;

FIG. 18A shows a state that the restriction member is attached to the socket main body, and FIG. 18B is an enlarged view of part of FIG. 18A, that is, one restriction wall and its neighborhood;

FIG. 19A is a sectional view taken along line D-D in FIG. 18A, and FIG. 19B is an enlarged view of part of FIG. 19A, that is, one terminal containing portion and its neighborhood;

FIG. 20A shows a state before attachment of the light leakage prevention cover and a bulb to the socket main body, and FIG. 20B shows a state that the light leakage prevention cover and the bulb are attached to the socket main body;

FIG. 21 is an exploded perspective view of an illumination device according to a second embodiment of the present disclosure;

FIG. 22A is a front view, as viewed from the side of a light leakage prevention cover, of the illumination device shown in FIG. 21 to which a translucent lens has not been attached yet, and FIG. 22B is a view of the illumination device as view from the direction indicated by arrow B in FIG. 22A;

FIG. 23A is a sectional view of the illumination device taken along line E-E in FIG. 22A, and FIG. 23B is an enlarged view of part of FIG. 23A, that is, a restriction wall and its neighborhood;

FIG. 24A is a sectional view of the illumination device taken along line F-F in FIG. 22B, and FIG. 24B is an enlarged view of part of FIG. 24A, that is, a restriction wall and its neighborhood; and

FIG. 25A is a top view of the light leakage prevention cover shown in FIG. 21, and FIG. 25B is a sectional view of the light leakage prevention cover taken along line G-G in FIG. 25A.

### DETAILED DESCRIPTION OF EXEMPLARY EMBODIMENTS

Locking structures of terminal fittings, bulb sockets, and illumination devices according to preferred embodiments of the present disclosure will be hereinafter described in detail with reference to the drawings.

### Embodiment 1

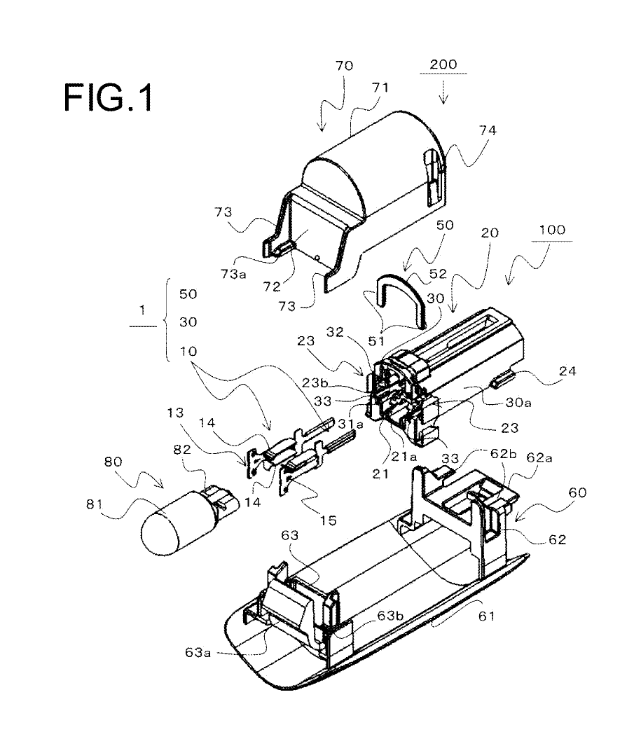

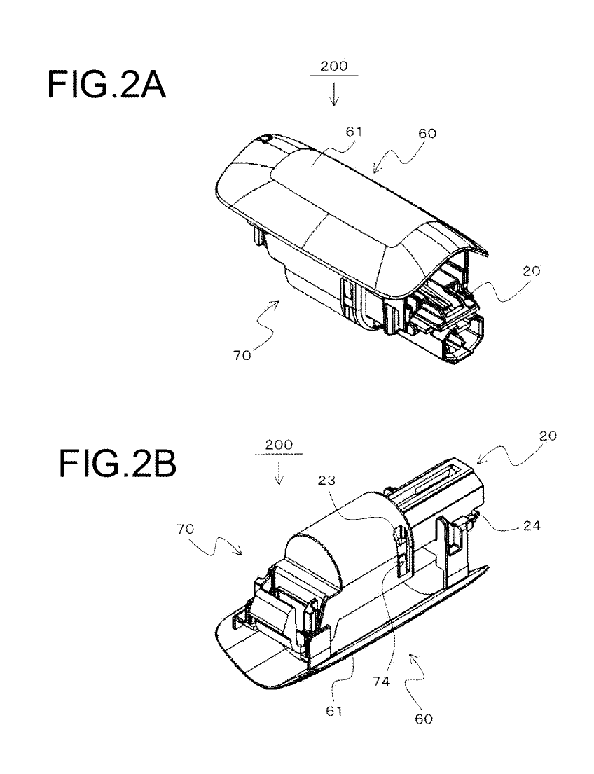

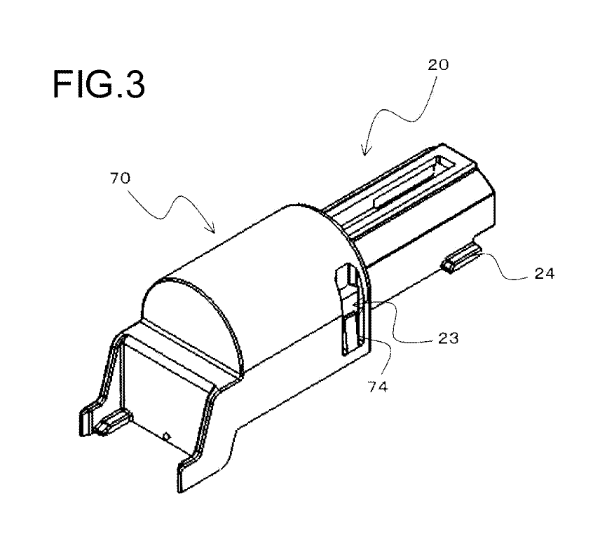

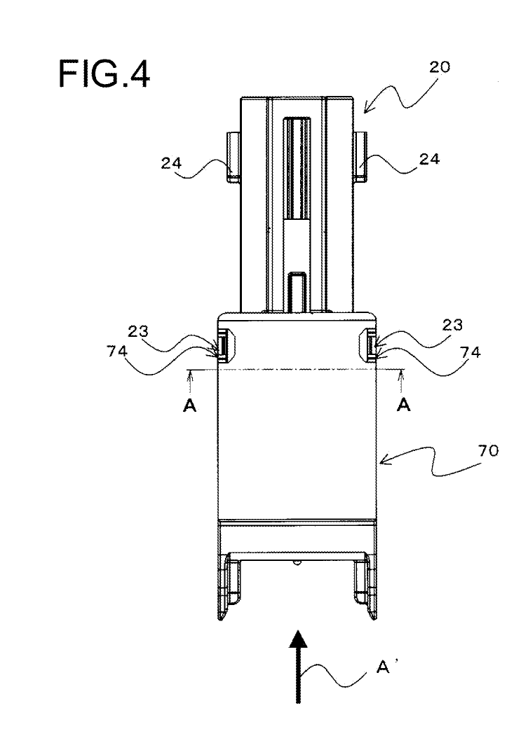

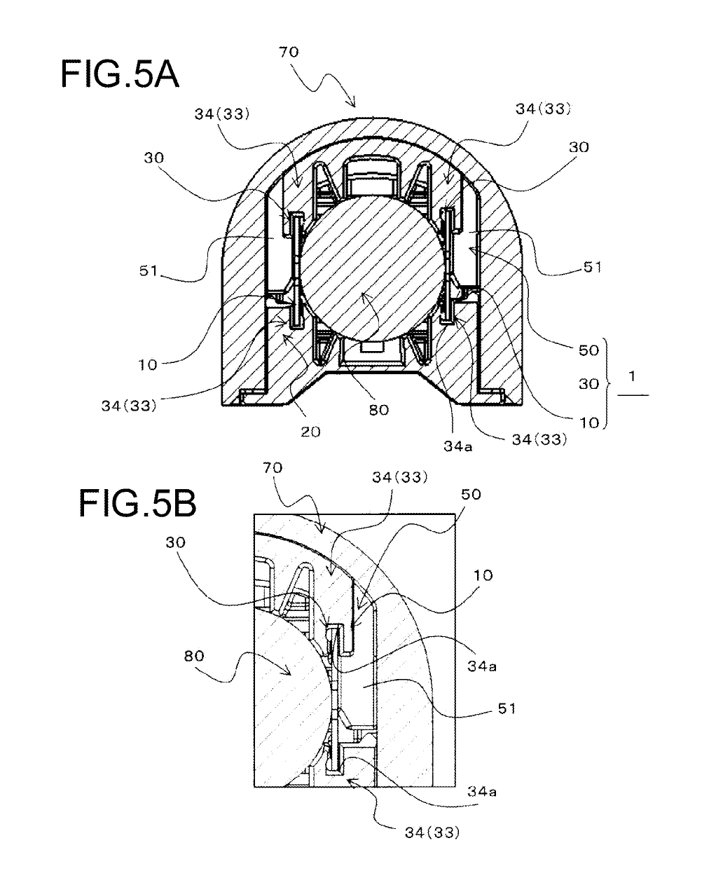

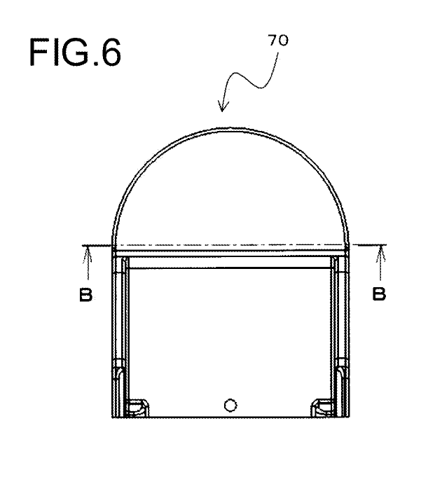

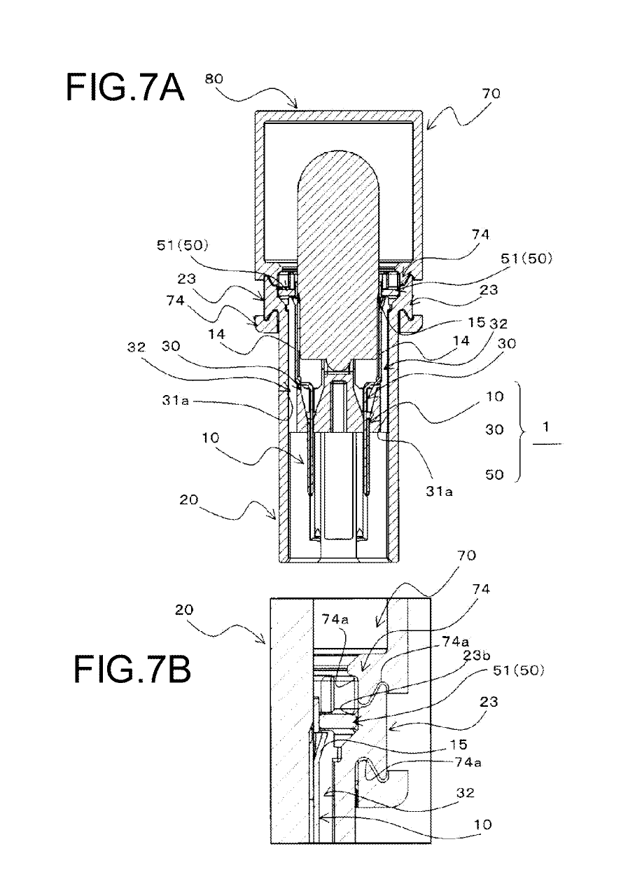

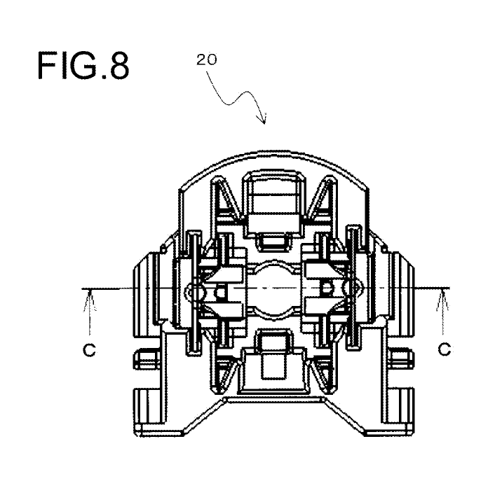

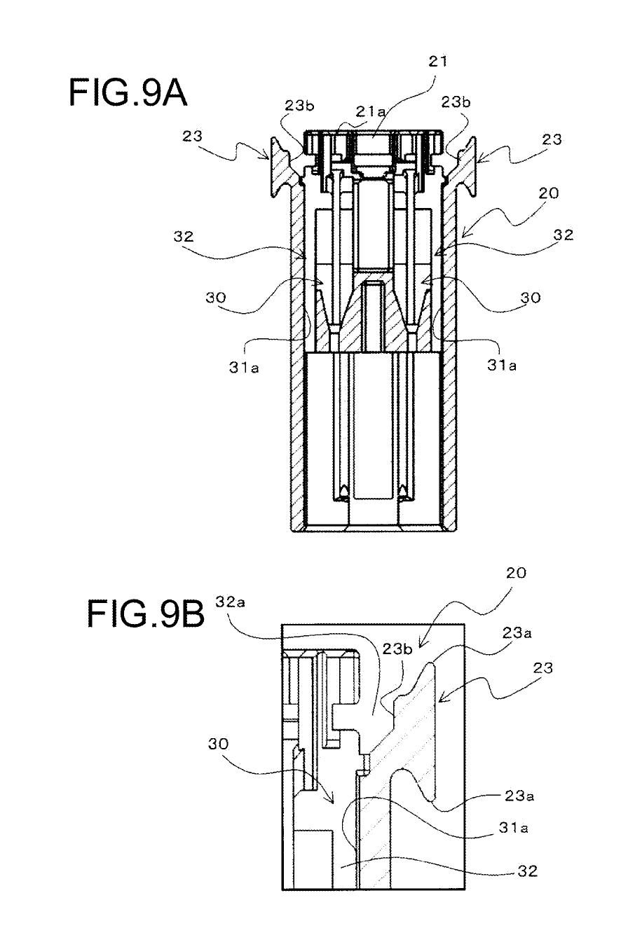

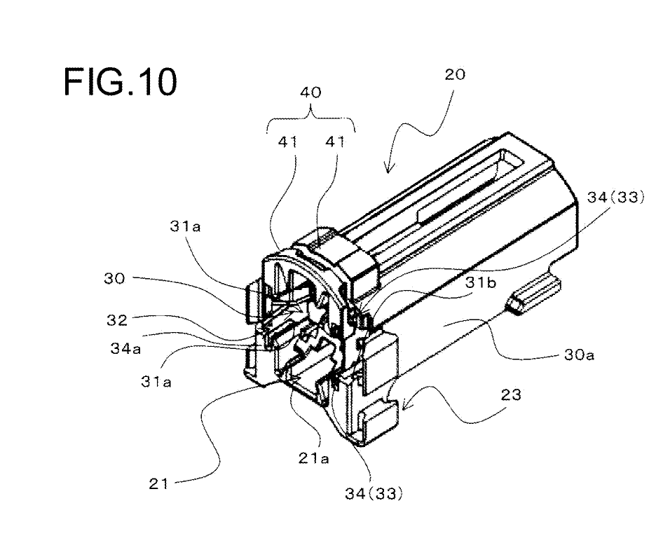

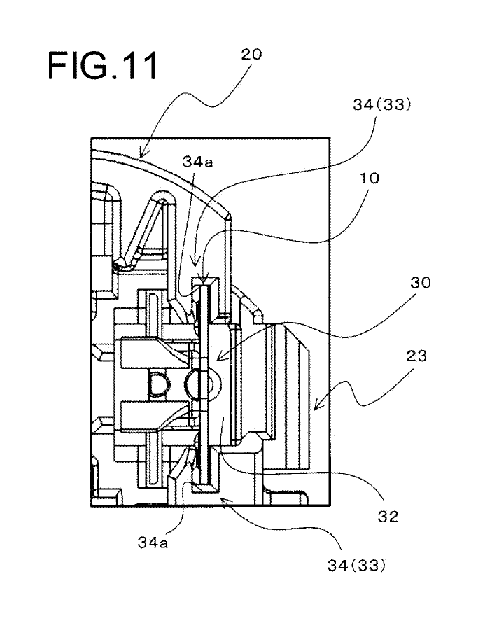

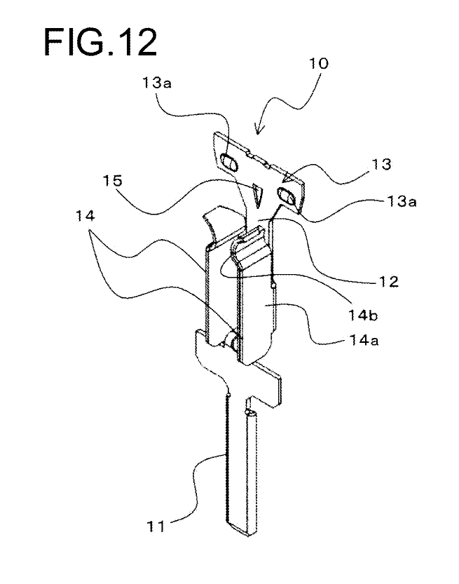

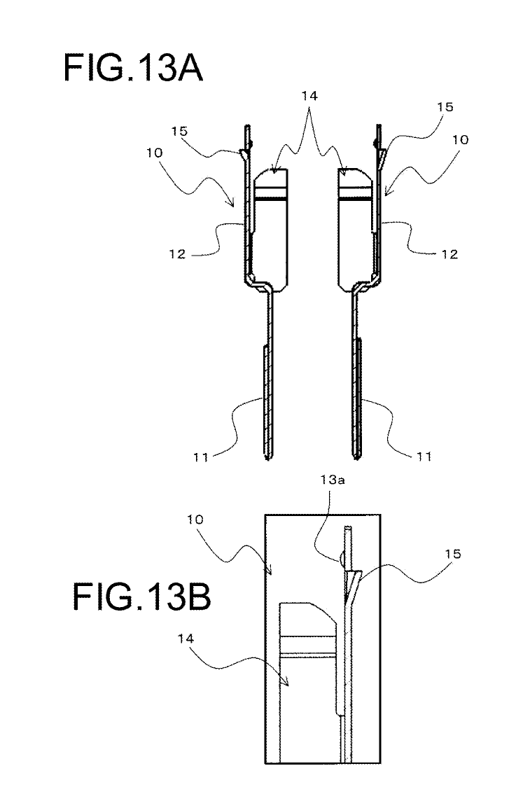

FIG. 1 is an exploded perspective view of an illumination device 200 according to a first embodiment of the present disclosure. FIG. 2A is a perspective view of the illumination device 200 as viewed from the side of a translucent lens 60, and FIG. 2B is a perspective view of the illumination device 200 as viewed from the side of a light leakage prevention cover 70. FIG. 3 is a perspective view, as viewed from the side of the light leakage prevention cover 70, of the illumination device 200 to which the translucent lens 60 has not been attached yet. FIG. 4 is a front view, as viewed from the side of the light leakage prevention cover 70, of the illumination device 200 in the same state as shown in FIG. 3. FIG. 5A is a sectional view of the illumination device 200 taken along line A-A in FIG. 4, and FIG. 5B is an enlarged view of part of FIG. 5A, that is, a restriction wall 51 and its neighborhood. FIG. 6 is a view of the illumination device 200 as view from the direction indicated by arrow A′ in FIG. 4. FIG. 7A is a sectional view of the illumination device 200 taken along line B-B in FIG. 6, and FIG. 7B is an enlarged view of part of FIG. 7A, that is, a restriction wall 51 and its neighborhood. FIG. 8 is a front view of a socket main body 20 as viewed from the side of an opening 21a of an insertion hole 21. FIG. 9A is a sectional view of the socket main body 20 taken along line C-C in FIG. 8, and FIG. 9B is an enlarged view of part of FIG. 9A, that is, a terminal containing portion 30 and its neighborhood. FIG. 10 is a perspective view of the socket main body 20. FIG. 11 is an enlarged view, as viewed from the side of the opening 21a of the insertion hole 21, of part of the socket main body 20 to which terminal fittings 10 are attached. FIG. 12 is a perspective view of one of the terminal fittings 10. FIG. 13A is a sectional view of the pair of terminal fittings 10, and FIG. 13B is an enlarged view of part of FIG. 13A, that is, a lock projection 15 and its neighborhood.

For example, the illumination device 200 according to the first embodiment of the present disclosure is a room illumination device that is installed in an automobile or the like. The illumination device 200 is equipped with a bulb 80 which is a light source, a bulb socket 100, the translucent lens 60 for transmitting, to outside the device, light emitted from the bulb 80, and the light leakage prevention cover 70 for preventing leakage of light through portions other than the translucent lens 60.

First, the bulb 80 will be described. As shown in FIG. 1, the bulb 80, which is what is called a wedge base bulb, is equipped with a light emitting unit 81 in which a filament (not shown) is disposed inside a cylindrical glass member and an electrode unit 82 which is provided with a pair of terminals (not shown), that is, an anode terminal and a cathode terminal.

Next, the bulb socket 100 will be described. The bulb socket 100, which incorporates a locking structure 1 of terminal fittings, serves to supply power to the bulb 80.

The locking structure 1 of terminal fittings is equipped with a pair of metal fittings 10 which are connected to the bulb 80, the socket main body 20 having two terminal containing portions 30 which hold and house the respective terminal fittings 10, and a restriction member 50.

The pair of metal fittings 10, which are what is called bus bars, are formed by punching a conductive metal plate and bending punched-out members. As shown in FIG. 13A, the pair of metal fittings 10 are attached to the socket main body 20 so as to be opposed to each other in a left-right symmetrical manner.

Each terminal fitting 10 has a fixing portion 11 which is fixed to the socket main body 20 and is to be connected to a cable (not shown), an extension portion 12 which extends from the fixing portion 11, press-fit portions 13 which project from the respective sides of a tip portion of the extension portion 12 so as to increase the width, a pair of terminal portions 14 which are bent from respective portions of the side edges of the extension portion 12 and are parallel with each other, and a lock projection 15 which is formed by cutting and erecting a portion of the extension portion 12 so as to assume a nail-like shape.

The fixing portion 11 assumes a plate-like shape and extends in the top-bottom direction in FIG. 12 (longitudinal direction). The fixing portion 11 is disposed at a deep position inside the terminal containing portion 30.

The extension portion 12 is bent from the fixing portion 11 and then bent again so as to extend parallel with the fixing portion 11 toward the opening 21a of the insertion hole 21 (a crank shape is formed).

The press-fit portions 13 are portions that are held by the respective terminal containing portions 30. The press-fit portions 13 project perpendicularly from the two respective sides of the tip portion of the extension portion 12, and the press-fit portions 13 and the extension portion 12 assume a T shape. Therefore, the press-fit portions 13 and the lock projection 15 are not aligned in the direction in which the terminal fitting 10 is inserted into the terminal containing portion 30.

The press-fit portions 13 have respective positioning projections 13a which project from their surfaces to the side that is opposite to the side to which the lock projection 15 projects. The press-fit portions 13 are press-fitted into the respective terminal press-fit holding portions 33 (described later) so that the terminal fitting 10 is positioned at the lock position and held there.

Each of the pair of terminal portions 14 has a spring portion 14a which is bent from a side portion of the extension portion 12 (i.e., supported on one side) and extends toward the opening 21a of the insertion hole 21 and a contact portion 14b which is formed by bending a tip portion of the spring portion 14a so as to have a certain curved surface.

Having the above structure, the pair of terminal portions 14 nip the electrode unit 82 of the bulb 80 which is inserted in the insertion hole 21 and are thereby electrically connected to the electrode (not shown) provided in the electrode unit 82.

Next, the socket main body 20 will be described. The socket main body 20 is the main body of the bulb socket 100. The socket main body 20 is made of an insulating material such as a synthetic resin and generally assumes a cylindrical shape. Cables (not shown) are wired inside the socket main body 20 through the light leakage prevention cover 70 and connected to the respective terminal fittings 10, whereby power is supplied to the bulb 80.

The socket main body 20 has the insertion hole 21 which receives the electrode unit 82 of the bulb 80, the pair of terminal containing portions 30 which form spaces that are continuous with the insertion hole 21 and thereby hold and house the respective terminal fittings 10, a restriction member holding portion 40 which holds the restriction member 50, cover lock portions 23 which are locked on the light leakage prevention cover 70, and lens engagement portions 24 which are engaged with the translucent lens 60.

Each terminal containing portion 30 has a guide space 32 through which the terminal fitting 10 is guided to the lock position for the lock projection 15 while a gap is formed between the lock projection 15 and an inner wall surface 31a of the terminal containing portion 30 and the terminal press-fit holding portions 33 which are press-fitted with the respective press-fit portions 13 and thereby hold the terminal fitting 10 at the lock position.

The guide space 32 is a space that is continuous with the insertion hole 21. When the terminal fitting 10 is inserted into the terminal containing portion 30, the guide space 32 prevents the lock projection 15 from coming into contact with the inner wall surface 31a of the terminal containing portion 30 which is opposed to the lock projection 15 in the projection direction of the lock projection 15.

As shown in FIGS. 9A and 9B, an enlarged gap space 32a where the width of the gap between the terminal fitting 10 and the inner wall surface 31a of the terminal containing portion 30 is increased and into which the restriction wall 51 of the restriction member 50 can be inserted is formed adjacent to an opening end of the guide space 32.

The enlarged gap space 32a is formed in such a manner that a cut 31 b is formed in a wall 30a of the terminal containing portion 30 so as to extend inward from the opening 21a of the insertion hole 21 so as to expose a neighborhood of the side surface of an end portion of the terminal fitting 10 and the cover lock portion 23 is formed so as to project toward the end of the socket main body 20 so as to cover the cut 31b.

With this structure, before the restriction member 50 is attached to the socket main body 20, that is, the terminal containing portions 30, each lock projection 15 is not locked because the terminal containing portion 30 has no portion on which it is to be locked. That is, the terminal fitting 10 is held in the terminal containing portions 30 by the forces for holding the press-fit portions 13.

Each pair of terminal press-fit holding portions 33 are provided in the corresponding terminal containing portion 30 so as to be press-fitted with and thereby hold the respective press-fit portions 13 of the terminal fitting 10. Each pair of terminal press-fit holding portions 33 have, at top and bottom positions adjacent to the insertion hole 21, press-fit groove portions 34 which are press-fitted with the press-fit portions 13, respectively. Each press-fit groove portion 34 is formed with a press-fit groove 34a which extends inward from an end portion, adjacent to the opening 21a of the insertion hole 21, of the socket main body 20.

The groove depth of each pair of (top and bottom) press-fit groove portions 34 is set so as not to interfere with the lock projection 15. More specifically, the groove depth is set approximately equal to the width of the press-fit portions 13.

The restriction member holding portion 40 serves to hold the restriction member 50. The restriction member holding portion 40 is composed of a pair of confronting walls 41 (see FIG. 10) for holding the restriction member 50 in place when a link portion 52 (described later) of the restriction member 50 is inserted between them. The pair of confronting walls 41 are erected from the top surface of an end portion, adjacent to the opening 21a of the insertion hole 21, of the socket main body 20 so as to be opposed to each other. When the link portion 52 is placed between the pair of confronting walls 41, each restriction wall 51 comes to be located between the terminal fitting 10 and the cover lock portion 23 and the cover lock portion 23 and closer to the destination side in the terminal fitting 10 releasing direction than the lock projection 15 is.

The cover lock portions 23 are formed on two side portions, adjacent to the cuts 31b, of the socket main body 20 so as to cover the cuts 31b from outside, respectively. Each cover lock portion 23 has a pair of projected guide flanges 23a which extend straightly in the direction in which the light leakage prevention cover 70 is slid when it is attached to the socket main body 20. The pair of projected guide flanges 23a are locked on a corresponding lock counterpart portion 74 (described later) of the light leakage prevention cover 70 when the pair of projected guide flanges 23a are slid relative to and fitted into respective guide grooves 74a of the lock counterpart portion 74.

Next, the restriction member 50 will be described. The restriction member 50 has the restriction walls 51 each of which is hit by the lock projection 15 and thereby prevents the terminal fitting 10 from coming off the terminal containing portion 30 when the terminal fitting 10 starts to do so. The restriction member 50 is a member that is separate from the terminal containing portions 30 and is attached to the terminal containing portions 30.

The restriction member 50 is made of an insulating material such as a synthetic resin, and is generally shaped like a gate so as to be able to be attached to the socket main body 20 so as to extend along the top surface and the side surfaces of an end portion of the socket main body 20. The restriction member 50 is composed of the pair of restriction walls 51 and the link portion 52 which connects the tops of the pair of restriction walls 51. The width of the restriction walls 51 is set slightly smaller than that of each gap space between the terminal fitting 10 located at the lock position and the cover lock portion 23.

The restriction member 50 having the above structure is attached to the terminal containing portions 30 in such a manner that each restriction wall 51 is placed between the terminal fitting 10 located at the lock position and the cover lock portion 23 and closer to the destination side in the terminal fitting 10 releasing direction than the lock projection 15 is.

Therefore, each restriction wall 51 is hit by the lock projection 15 and thereby prevents the terminal fitting 10 from coming off the terminal containing portion 30 even when the terminal fitting 10 starts to do so. Thus, each restriction wall 51 allows the lock projection 15 to be locked with a strong locking force.

The locking force can be adjusted by adjusting the projection height of each lock projections 15, that is, the cutting-and-erection height of the nail-like portion; the locking force can easily be adjusted to a desired value.

The translucent lens 60 is made of a light transparent resin material, and is composed of a lens main body 61 which is shaped like a curved plate and a first attachment portion 62 and a second attachment portion 63 which project from the inner surface of the lens main body 61.

The first attachment portion 62 has a lock piece 62a which projects outward parallel with an end portion, opposite to the opening 21a of the insertion hole 21, of the socket main body 20 and a pair of first engagement portions 62b which can be engaged with respective lens engagement portions 24 of the socket main body 20. The second attachment portion 63 has a lock portion 63a which can be engaged with an interior member (not shown) of a vehicle and a pair of second engagement portions 63b which can be engaged with respective lens engagement portions 73a of the light leakage prevention cover 70.

The light leakage prevention cover 70 is made of an insulating material such as a synthetic resin, and is composed of a cover main body 71 which is generally shaped like a semicylinder, an end wall 72 which is continuous with one end portion of the cover main body 71 and covers the light emitting unit 81 of the bulb 80 that is attached to the socket main body 20, and a pair of flanges 73 which project from the sides of the end wall 72.

The inner surface of the cover main body 71 is formed with a reflection surface (not shown) for reflecting, toward the translucent lens 60, light emitted from the light emitting unit 81 so that light can be radiated outward efficiently from the translucent lens 60.

The cover main body 71 is also formed with the pair of lock counterpart portions 74 on which the respective cover lock portions 23 of the socket main body 20 are locked. Each lock counterpart portion 74 has the pair of guide grooves 74a which are fitted with the respective projected guide flanges 23a of the corresponding cover lock portion 23. The light leakage prevention cover 70 is pressed downward (as viewed in FIG. 1) against the socket main body 20, whereby the guide grooves 74a come to be fitted with the respective projected guide flanges 23a.

Since the cover lock portions 23 are locked on the respective lock counterpart portions 74 in the above manner, each lock counterpart portion 74 is placed so as to cover the two side portions of the corresponding cover lock portion 23. That is, the cover lock portions 23 are locked on the respective lock counterpart portions 74 in such a manner that the latter support the former.

The inner wall surfaces 23b of the cover lock portions 23 which are made stronger as a result of their locking on the respective lock counterpart portions 74 of the light leakage prevention cover 70 prevent bending or positional deviation of the restriction walls 51. As a result, the lock projections 15 can be locked with stronger locking forces. The inner wall surface 23b of each cover lock portion 23 is part of the inner wall 31 a of the terminal containing portion 30.

The flanges 73 have the respective lens engagement portions 73a which are engaged with the translucent lens 60. The lens engagement portions 73a are slid to be engaged with the respective second engagement portions 63b of the translucent lens 60.

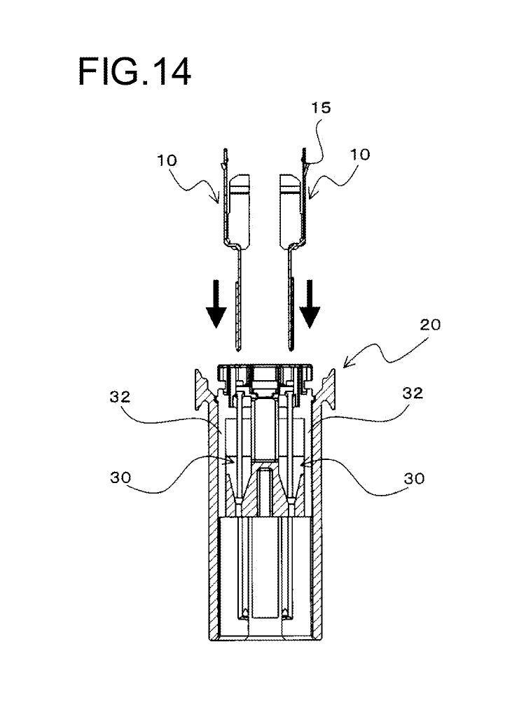

Next, an assembling procedure of the illumination device 200 according to the first embodiment of the present disclosure and how the individual portions work during that course will be described with reference to FIG. 14 to FIGS. 20A and 20B.

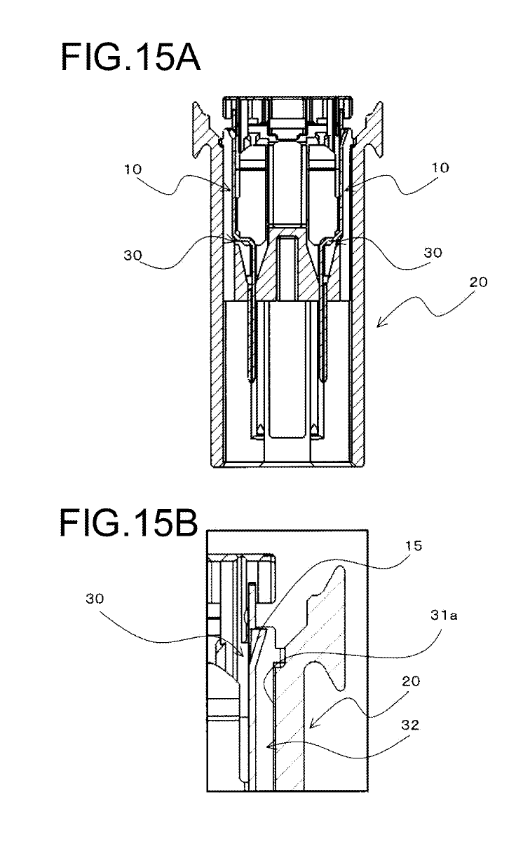

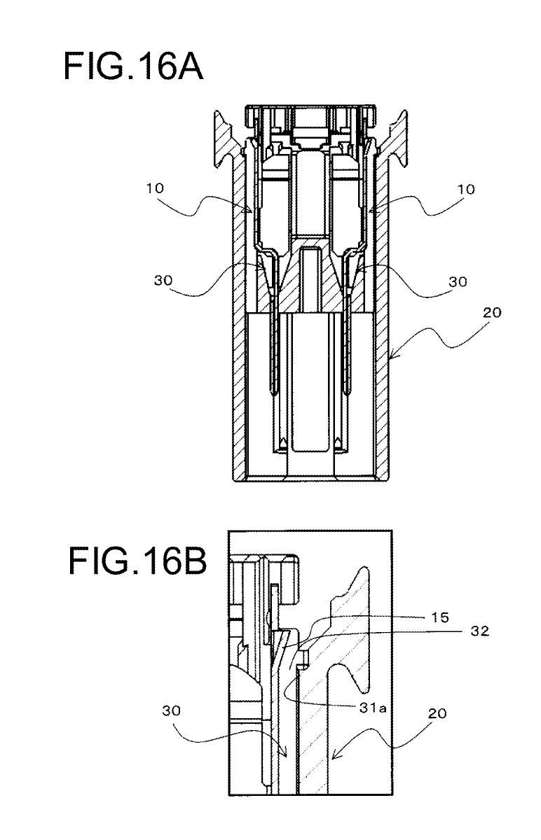

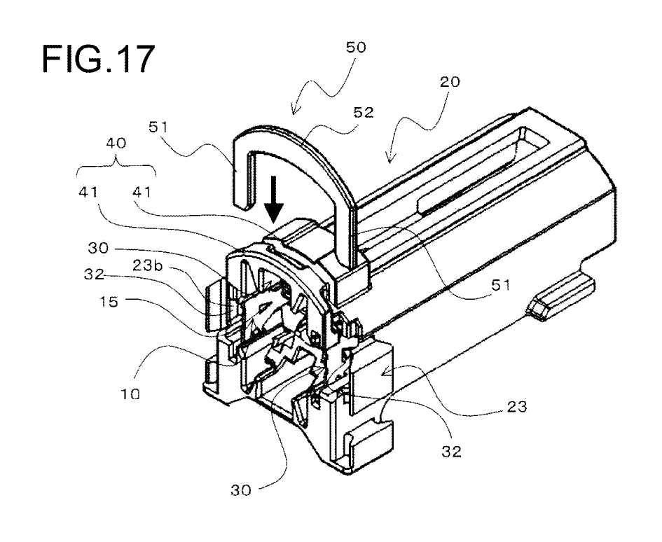

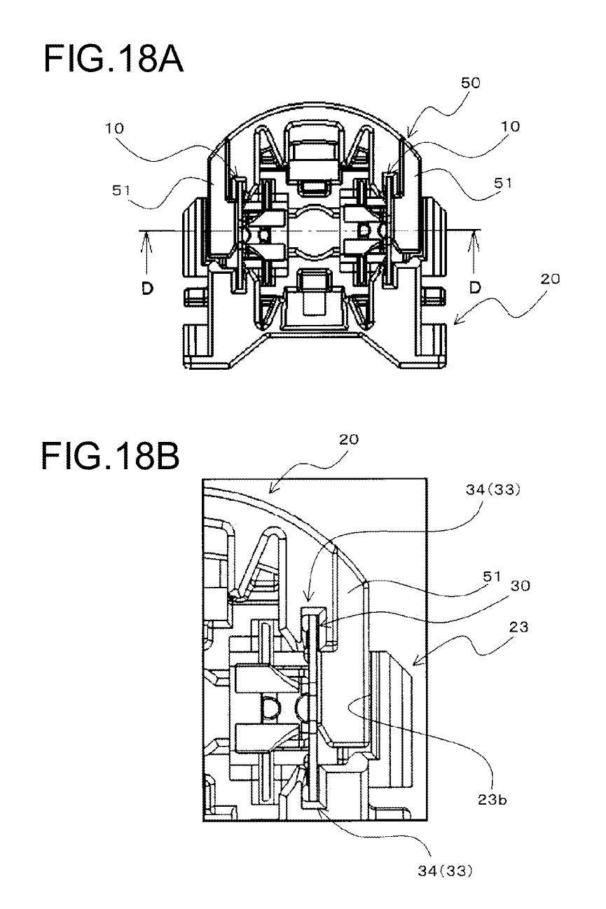

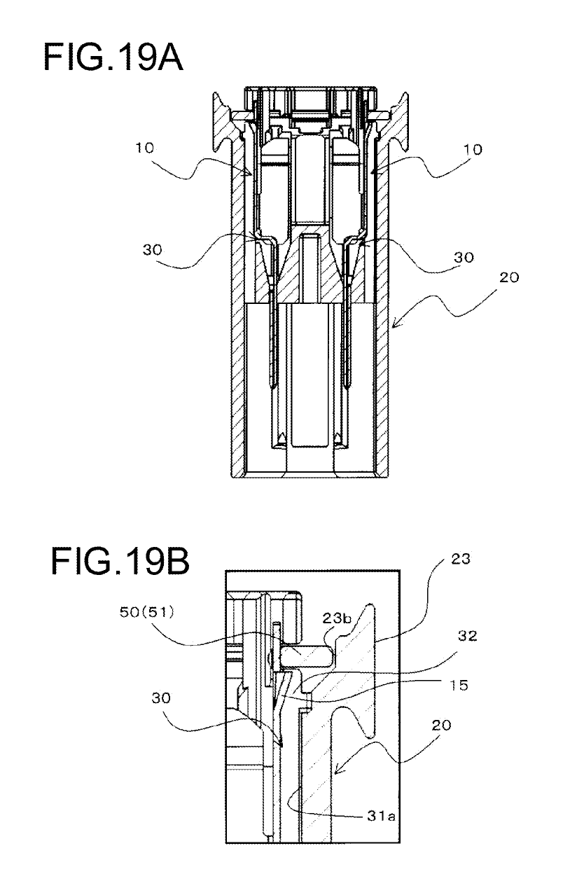

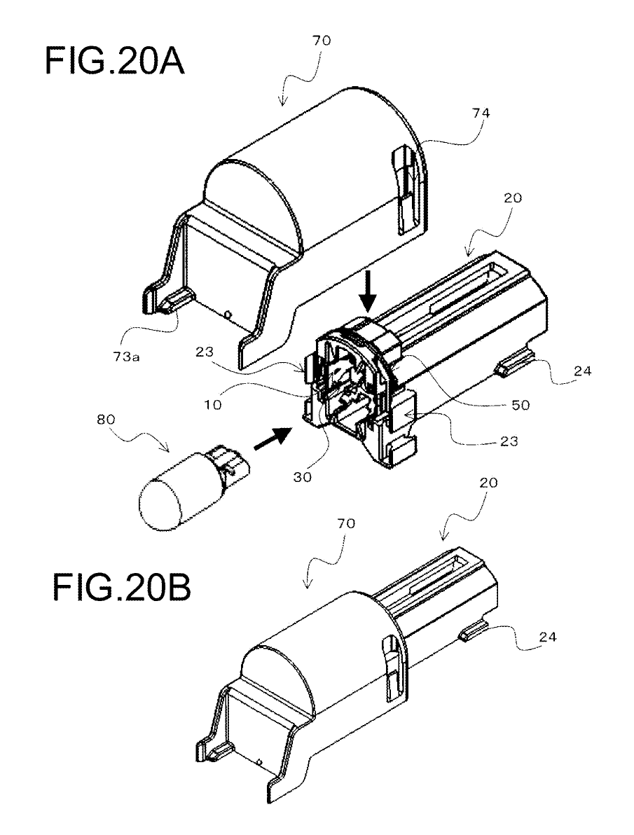

FIG. 14 shows a state before insertion of the pair of terminal fittings 10 into the respective terminal containing portions 30 of the socket main body 20. FIG. 15A shows a state immediately before the pair of terminal fittings 10 reach the lock positions, and FIG. 15B is an enlarged view of part of FIG. 15A, that is, one terminal containing portion 30 and its neighborhood. FIG. 16A shows a state that the terminal fittings 10 are set in place, and FIG. 16B is an enlarged view of part of FIG. 16A, that is, one terminal containing portion 30 and its neighborhood. FIG. 17 shows a state before attachment of the restriction member 50 to the socket main body 20. FIG. 18A shows a state that the restriction member 50 is attached to the socket main body 20, and FIG. 18B is an enlarged view of part of FIG. 18A, that is, one restriction wall 51 and its neighborhood. FIG. 19A is a sectional view taken along line D-D in FIG. 18A, and FIG. 19B is an enlarged view of part of FIG. 19A, that is, one terminal containing portion 30 and its neighborhood. FIG. 20A shows a state before attachment of the light leakage prevention cover 70 and the bulb 80 to the socket main body 20, and FIG. 20B shows a state that the light leakage prevention cover 70 and the bulb 80 are attached to the socket main body 20.

First, the worker inserts the pair of terminal fittings 10 into the respective terminal containing portions 30 of the socket main body 20 (see FIG. 14 to FIGS. 16A and 16B).

As seen from FIGS. 15A and 15B, the terminal fittings 10 can move to the lock positions while the lock projections 15 of the terminal fittings 10 move through the guide spaces 32 without coming into contact with the inner walls 31a of the terminal containing portions 30, respectively.

When each terminal fitting 10 reaches the lock position, the press-fit portions 13 are press-fitted into the press-fit grooves 34a of the terminal press-fit holding portions 33, respectively, and held at the lock position in the terminal containing portion 30 by means of the positioning projections 13a of the terminal fitting 10.

Although the terminal fittings 10 are held by the terminal press-fit holding portions 33 at the lock positions, the lock projections 15 have not been locked yet. That is, since the terminal fittings 10 are in temporarily held states, the lock projections 15 may release (come off) the respective terminal containing portions 30 if they receive strong forces in such directions as to be released from the respective terminal containing portions 30.

Then the worker attaches the restriction member 50 to the terminal containing portions 30 (see FIG. 17 to FIGS. 19A and 19B). That is, as shown in FIG. 17, the worker pushes the link portion 52 of the restriction member 50 into the space between the pair of confronting walls 41 of the restriction member holding portion 40 from above the socket main body 20.

As a result, each restriction wall 51 is placed between the terminal fitting 10 located at the lock position and the cover lock portion 23 and closer to the destination side in the terminal fitting 10 releasing direction than the lock projection 15 is. Therefore, each restriction wall 51 is hit by the lock projection 15 and thereby prevents the terminal fitting 10 from coming off the terminal containing portion 30 even when the terminal fitting 10 starts to do so.

Subsequently, as shown in FIGS. 20A and 20B, the worker attaches the bulb 80 to the socket main body 20. And the worker attaches the light leakage prevention cover 70 to the socket main body 20. This is done by locking the pair of cover lock portions 23 of the socket main body 20 on the respective lock counterpart portions 74 of the light leakage prevention cover 70. As a result, the two side portions of each cover lock portion 23 are supported by the corresponding lock counterpart portion 74.

Finally, the worker attaches the translucent lens 60 to the assembly of the bulb socket 100 and the light leakage prevention cover 70. More specifically, the worker slides the assembly of the bulb socket 100 and the light leakage prevention cover 70 with respect to the translucent lens 60, whereby the pair of lens engagement portions 73a of the light leakage prevention cover 70 are engaged with the respective second engagement portions 63b of the translucent lens 60 and the pair of first lens engagement portions 24 of the socket main body 20 are engaged with the respective first engagement portions 62b of the translucent lens 60.

According to the locking structure 1 of terminal fittings according to the first embodiment of the present disclosure, since the terminal fittings 10 are moved to the lock positions while the lock projections 15 move through the guide spaces 32 without coming into contact with the inner walls 31a of the terminal containing portions 30, respectively, deformation of the lock projections 15 can be prevented. Furthermore, since the restriction member 50 prevents coming-off of the terminal fittings 10, strong locking forces can be obtained. As a result, lowering of the forces for locking of the terminal fittings 10 can be prevented.

Furthermore, in the locking structure 1 of terminal fittings according to the first embodiment of the present disclosure, each terminal fitting 10 can be held at the lock position by press-fitting its press-fit portions 13 into the respective terminal press-fit holding portions 33. This facilitates assembling work.

The bulb socket 100 according to the first embodiment of the present disclosure incorporates the locking structure 1 of terminal fittings. Therefore, since the terminal fittings 10 are moved to the lock positions while the lock projections 15 move through the guide spaces 32 without coming into contact with the inner walls 31a of the terminal containing portions 30, respectively, deformation of the lock projections 15 can be prevented. Furthermore, since the restriction member 50 prevents coming-off of the terminal fittings 10, strong locking forces can be obtained. As a result, lowering of the forces for locking of the terminal fittings 10 can be prevented.

The illumination device 200 according to the first embodiment of the present disclosure incorporates the bulb socket 100. Therefore, as in the bulb socket 100, lowering of the forces for locking of the terminal fittings 10 can be prevented.

Furthermore, in the illumination device 200 according to the first embodiment of the present disclosure, the inner wall surfaces 23b of the cover lock portions 23 which are made stronger as a result of their locking on the respective lock counterpart portions 74 of the light leakage prevention cover 70 prevent bending or positional deviation of the restriction walls 51. As a result, the forces for locking of the terminal fittings 10 can be increased further.

### Embodiment 2

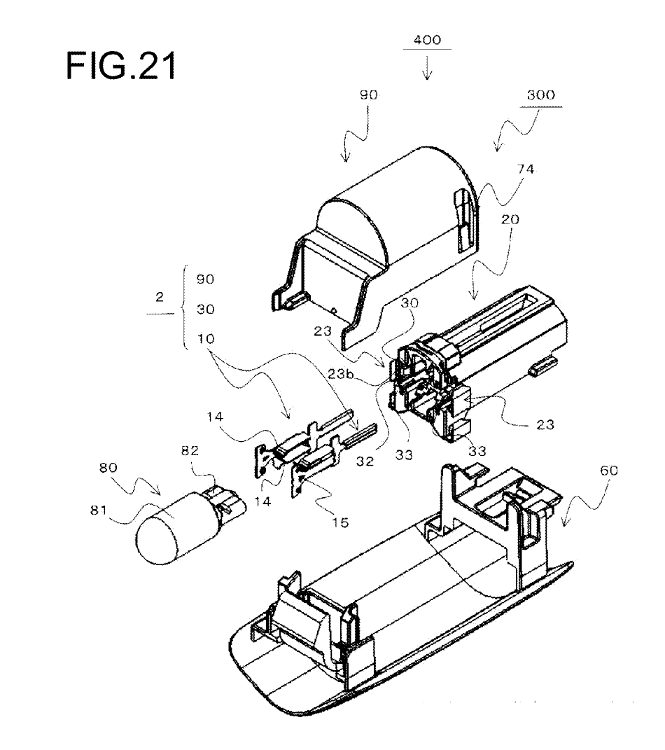

A locking structure 2 of terminal fittings, a bulb socket 300, and an illumination device 400 according to a second embodiment of the present disclosure will be described below with reference to FIG. 21 to FIGS. 25A and 25B.

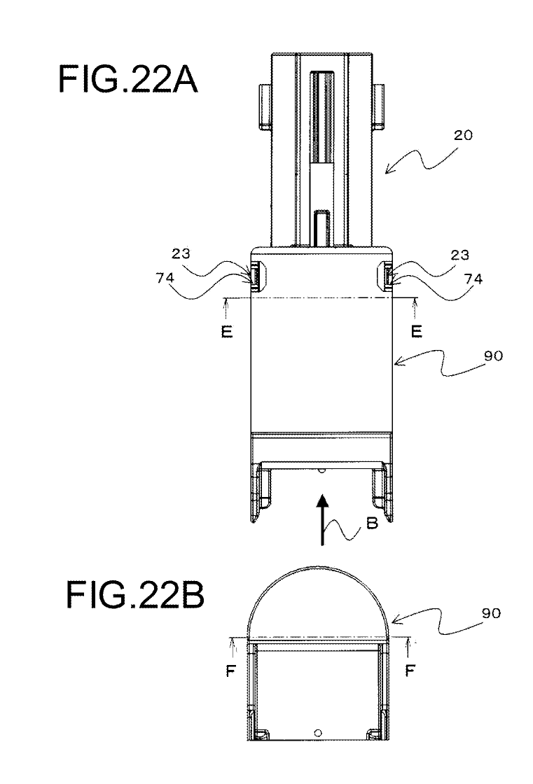

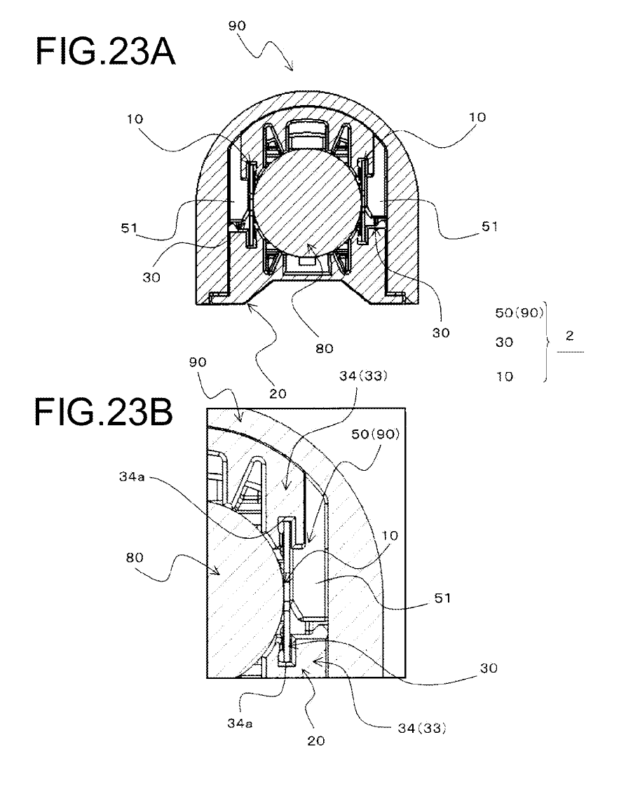

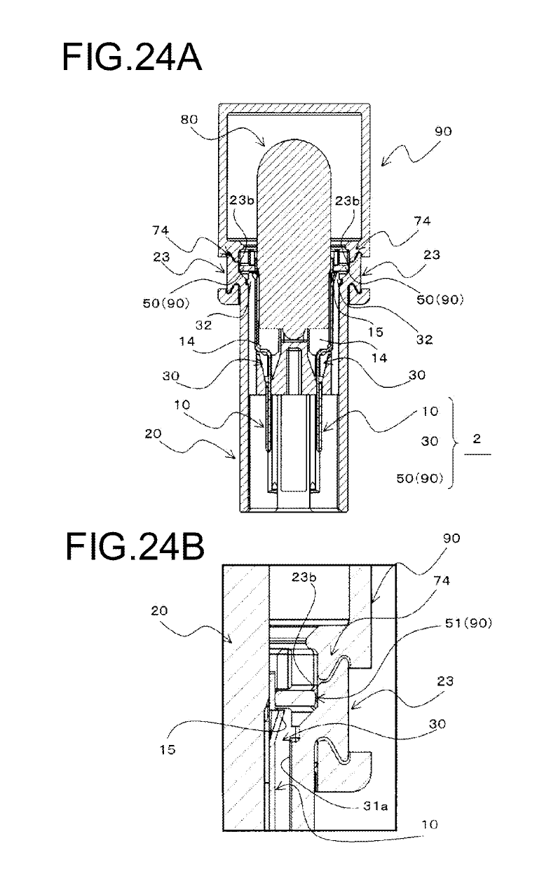

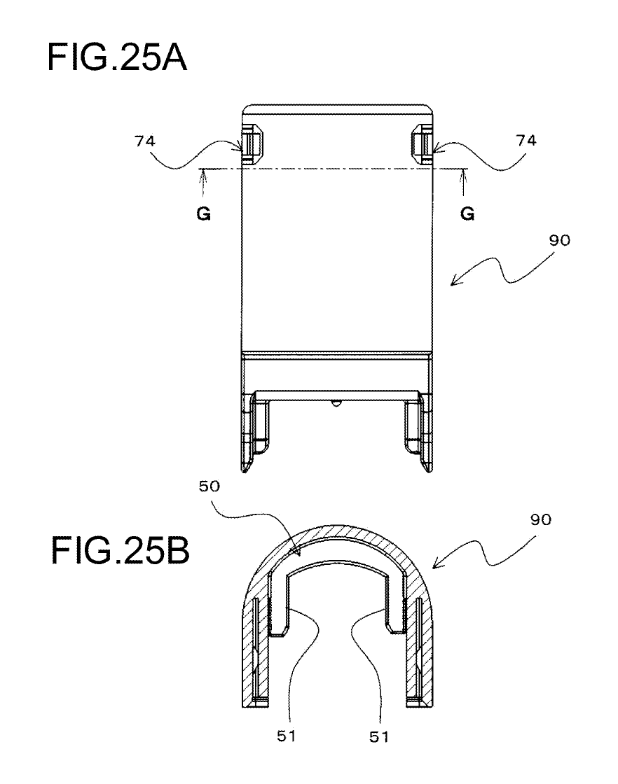

FIG. 21 is an exploded perspective view of the illumination device 400 according to the second embodiment of the present disclosure. FIG. 22A is a front view, as viewed from the side of a light leakage prevention cover 90, of the illumination device 400 shown in FIG. 21 to which a translucent lens 60 has not been attached yet, and FIG. 22B is a view of the illumination device 400 as view from the direction indicated by arrow B in FIG. 22A. FIG. 23A is a sectional view of the illumination device 400 taken along line E-E in FIG. 22A, and FIG. 23B is an enlarged view of part of FIG. 23A, that is, a restriction wall 51 and its neighborhood. FIG. 24A is a sectional view of the illumination device 400 taken along line F-F in FIG. 22B, and FIG. 24B is an enlarged view of part of FIG. 24A, that is, a restriction wall 51 and its neighborhood. FIG. 25A is a top view of the light leakage prevention cover 90 shown in FIG. 21, and FIG. 25B is a sectional view of the light leakage prevention cover 90 taken along line G-G in FIG. 25A.

In the locking structure 1 of terminal fittings, the bulb socket 100, and the illumination device 200 according to the first embodiment of the present disclosure, the restriction member 50 and the light leakage prevention cover 70 are separate from each other. In contrast, in the locking structure 2 of terminal fittings, the bulb socket 300, and the illumination device 400 according to the second embodiment of the present disclosure, the restriction member 50 used in the first embodiment is integrated with the light leakage prevention cover 90. The other members etc. are the same as in the first embodiment, and constituent elements having the same ones in the first embodiment will be given the same reference symbols as the latter.

In the locking structure 2 of terminal fittings, the light leakage prevention cover 90 itself has the function of the restriction member 50 used in the first embodiment. When the light leakage prevention cover 90 is attached to the socket main body 20 in which the terminal fittings 10 are inserted, as shown in FIGS. 23A and 23B and FIGS. 24A and 24B each restriction wall 51 is placed between the terminal fitting 10 located at the lock position and the cover lock portion 23 and closer to the destination side in the terminal fitting 10 releasing direction than the lock projection 15 is.

When each terminal fitting 10 is inserted into the terminal containing portion 30, it moves through the guide space 32 and hence the lock projection 15 does not come into contact with the inner wall 31a of the terminal containing portion 30. Therefore, each terminal fitting 10 can move to the lock position in such a manner that the lock projection 15 is not deformed elastically.

The locking structure 2 of terminal fittings, the bulb socket 300, and the illumination device 400 according to the second embodiment of the present disclosure provide the same advantages as the locking structure 1 of terminal fittings, the bulb socket 100, and the illumination device 200 according to the first embodiment of the present disclosure. Furthermore, since the restriction member 50 is integrated with the light leakage prevention cover 90, the number of components of the illumination device 400 is decreased and hence work of assembling it is facilitated.

Although the locking structures 1 and 2 of terminal fittings according to the first and second embodiments of the present disclosure are such as to be incorporated in the bulb sockets 100 and 300 and the illumination devices 200 and 400, respectively, the present disclosure is not limited to such a case. The present disclosure may also be applied to locking structures of a terminal fitting(s) to be incorporated in other components or devices such as connectors.

Although in the locking structures 1 and 2 of terminal fittings according to the first and second embodiments of the present disclosure the lock projection 15 of each terminal fitting 10 is a nail-shaped projection formed by cutting and erecting a portion of the extension portion 12, the present disclosure is not limited to such a case. Each lock projection 15 may have any other shape as long as it is a projection.

Although in the locking structures 1 and 2 of terminal fittings according to the first and second embodiments of the present disclosure each restriction wall 51 is placed between the terminal fitting 10 located at the lock position and the cover lock portion 23, the present disclosure is not limited to such a case. It suffices that each restriction wall 51 be provided so as to be hit by the lock projection 15 and thereby prevent coming-off of the terminal fitting 10 when the terminal fitting 10 has started to move in such a direction as to be released from the terminal containing portions 30. That is, it suffices that each restriction wall 51 be located closer to the destination side in the terminal fitting 10 releasing direction than the corresponding lock projection 15 is so as to be hit by the lock projection 15 when the terminal fitting 10 has started to move in such a direction as to be released from the terminal containing portions 30; the inner wall surface 23b of each cover lock portion 23 need not always be located outside the corresponding restriction wall 51.

Although the present disclosure made by the inventors has been described above in a specific manner using the embodiments of the present disclosure, the present disclosure is not limited to the above embodiments and various modifications are possible without departing from the spirit and scope of the present disclosure.

The present application is based on Japanese Patent Application No. 2013-255868 filed on Dec. 11, 2013, the contents of which are incorporated herein by reference.

What is claimed is:

1. A locking structure of a terminal fitting, comprising:
a terminal fitting;
a terminal containing portion that holds and contains the terminal fitting therein; and
a restriction member that is separate from and is attached to the terminal containing portion,
wherein the terminal fitting is locked in the terminal containing portion by a lock projection of the terminal fitting;
wherein the terminal containing portion has a guide space formed by a gap between the lock projection and an inner wall surface of the terminal containing portion to guide the terminal fitting to a lock position therethrough; and
wherein the restriction member has a restriction wall which is butted by the lock projection of the terminal fitting and thereby prevents from releasing of the terminal fitting when the terminal fitting is moved in such a direction as to be released from the terminal containing portion.

2. The locking structure of a terminal fitting according to claim 1, wherein the terminal fitting has a press-fit portion which is held by the terminal containing portion; and
wherein the terminal containing portion has a terminal press-fit holding portion which is press-fitted with the press-fit portion and thereby holds the terminal fitting at the lock position.

3. A bulb socket for supplying power to a bulb as a light source, comprising:
the locking structure of the terminal fitting according to claim 1,
wherein the terminal fitting has a terminal portion which is connected to the bulb; and
wherein the terminal containing portion is provided in a socket main body of the bulb socket.

4. An illumination device comprising:
a bulb as a light source;
a translucent lens for transmitting, to outside the illumination device, light emitted from the bulb;
a light leakage prevention cover that prevents leakage of light through a portion other than the translucent lens; and
the bulb socket according to claim 3.

5. The illumination device according to claim 4, wherein the socket main body has a cover lock portion which is locked on the light leakage prevention cover;
wherein the light leakage prevention cover has a lock counterpart portion on which the cover lock portion is locked so as to be supported by the cover lock portion; and
wherein the restriction member is attached to the terminal containing portion so that the restriction wall is placed between the terminal fitting located at the lock position and the cover lock portion and is placed closer to a destination side in a releasing direction, in which the terminal fitting is released from the terminal containing portion, than the lock projection.

6. The illumination device according to claim 4, wherein the restriction member is integrally formed on the light leakage prevention cover.
